(19) United States
(12) Patent Application Publication
(10) Pub. No.: US 2024/0144331 A1
(43) Pub. Date: May 2, 2024

(54) REAL ESTATE DATA SYSTEM

(71) Applicant: Imagine Lobs, Inc, Belvedere, CA (US)

(72) Inventor: Rotem Perelmuter, Belvedere, CA (US)

(21) Appl. No.: 17/975,395

(22) Filed: Oct. 27, 2022

(51) Int. Cl. G06Q 30/06; G06Q 50/16

(52) U.S. Cl. CPC G06Q 30/06; G06Q 50/163; G06Q 2220/00

(57) ABSTRACT

A real estate data system deploys smart contracts on distributed ledgers. The smart contract includes data identifying real property, a lessor of the real property, a lessee of the real property, a service provider that will provide services to the parties to the smart contract, terms of a lease agreement between the lessee and the lessor, conditions to be met when transferring the lease from the lessee to another lessee, or any suitable combination thereof. The lease agreement may be a lease with an option to buy (LOB) agreement that includes an option for the lessee to buy the real estate agreement and terminate the lease at a predetermined strike price. Use of a LOB instead of a sale may be enable participants to trade real estate without losing the advantages of below-market interest rates of their loans. A service provider may act as an intermediary in the lease transaction.

### TECHNICAL FIELD

The subject matter disclosed herein generally relates to computer systems for using distributed ledger technologies to manage real estate data and transactions. Specifically, the present disclosure addresses systems and methods to use distributed-ledger-based smart contracts to enable lease-with-an-option-to-buy real estate transactions.

### BACKGROUND

A distributed ledger comprises digital data geographically spread across multiple locations or entities. The digital data is replicated, shared, and synchronized between computing nodes storing the digital data. Unlike with a centralized database, no single entity administrates or controls the digital data. A peer-to-peer network is used for communication between the computing nodes. A consensus algorithm is used to resolve discrepancies in data between the computing nodes. Blockchain is a form of distributed ledger.

Each blockchain account has a unique cryptographic key. Only a user with knowledge of the key is permitted to change the contents of the account. Accounts are used to store fungible values (e.g., quantities of currency) and non-fungible tokens (NFTs).

Digital signatures are used to verify the authenticity of digital messages. A digital signature is generated using a private key of a private key/public key pair. The digital signature is verified using the public key. The signer maintains exclusive control of the private key and distributes the public key. An asymmetric cryptography algorithm used to generate the key pair is cryptographically secure, such that even with the public key and a set of encrypted messages, an attacker is unable to determine the private key with a predetermined amount of computing resources.

A seller of real estate may have a mortgage loan secured by the real estate, with the mortgage loan having a fixed interest rate that may be higher or lower than a current market interest rate. A buyer of the real estate gets a mortgage at the current market interest rate and the proceeds of the new mortgage loan are used to pay off the old mortgage loan.

### BRIEF DESCRIPTION OF THE DRAWINGS

Some embodiments are illustrated by way of example and not limitation in the figures of the accompanying drawings.

FIG. 1 is a network diagram illustrating a network environment suitable for a real estate data system, according to some example embodiments.

FIG. 2 is a block diagram of an application server, according to some example embodiments, suitable for managing smart contracts for a real estate data system.

FIG. 3 illustrates a blockchain architecture, according to some example embodiments.

FIG. 4 illustrates a blockchain architecture, according to some example embodiments.

FIG. 5 is a block diagram of a database schema, according to some example embodiments, suitable for use in a real estate data system.

FIG. 6 is a block diagram of a user interface, according to some example embodiments, for searching for real estate.

FIG. 7 is a block diagram of a user interface, according to some example embodiments, for displaying real estate search results.

FIG. 8 is a flowchart illustrating operations of a method suitable for identifying real estate and creating a smart contract for the real estate, according to some example embodiments.

FIG. 9 is a flowchart illustrating operations of a method suitable for modifying a smart contract for real estate, according to some example embodiments.

FIG. 10 is a flowchart illustrating operations of a method suitable for creating a smart contract for real estate, according to some example embodiments.

FIG. 11 is a block diagram showing one example of a software architecture for a computing device.

FIG. 12 is a block diagram of a machine in the example form of a computer system within which instructions may be executed for causing the machine to perform any one or more of the methodologies discussed herein.

### DETAILED DESCRIPTION

Example methods and systems are directed to use of a distributed ledger for a real estate data system. The real estate data system deploys smart contracts on distributed ledgers. The smart contract includes data identifying real property, a lessor of the real property, a lessee of the real property, a service provider that will provide services to the parties to the smart contract, terms of a lease agreement between the lessee and the lessor, conditions to be met when transferring the lease from the lessee to another lessee, or any suitable combination thereof.

The lease agreement may be a lease with an option to buy (LOB) agreement that includes an option for the lessee to buy the real estate agreement and terminate the lease at a predetermined strike price. The strike price is a lump sum that can be paid by lessee to cause ownership of the real estate to be transferred from the lessor to the lessee. The strike price may be reduced according to a fixed schedule over the term of the lease, approximating the pay schedule of a mortgage in which the principal of the mortgage is reduced over time.

Use of a LOB instead of a sale may be desirable when the interest rate of an existing mortgage on the real property is below the interest rate that would be applied to a new mortgage. For example, a homeowner may wish to move to a different city and purchase a comparable home. However, if interest rates have risen between the time of the original purchase and the time of the move, a loan of the same amount could have substantially higher monthly payments, making the move unattractive. Many homeowners may be in the same situation, reducing the liquidity in the market for homes.

By working within a LOB market, the homeowner continues to make payments on the existing mortgage at the existing interest rate, covered by lease payments from a LOB lessee. The homeowner engages, as a lessee, in another LOB agreement for a comparable property in the other city. The lease payments on the comparable property, which cover the existing mortgage on that property, are comparable in amount to the mortgage payments on the original property. Thus, the participants in the LOB market are enabled to trade real estate without losing the advantages of the below-market interest rates of their loans.

A service provider may act as an intermediary in the lease transaction, accepting monthly payments from the lessee, making mortgage payments to the lender, making property tax payments, taking a service fee, and providing the remainder to the lessor. The service provider may also record the payment history and update the strike price of the lease.

The LOB agreement may include an upfront payment that is analogous to the down payment of a purchase agreement. In various example embodiments, the upfront payment may be refundable, partially refundable, or non-refundable if the LOB agreement is terminated. A portion of the upfront payment may be paid to the owner of the real estate, to the servicer of the LOB agreement, or both. The LOB agreement may include prepayment penalties.

The owner of the real estate may be entitled to receive a percentage of a subsequent transaction (either LOB or sale). For example, the lessee may be permitted to transfer the LOB to another lessee, but the owner may be entitled to a portion (e.g., 10% or 50%) of any increase in the value of the real estate that has occurred.

The service provider may receive an upfront transaction fee, provide title insurance, receive an annual fee to maintain a smart contract for the LOB agreement, receive a percentage of a sale amount when the purchase option is exercised, guarantee lease payments, or any suitable combination thereof.

Use of a distributed ledger to record and implement the terms of the LOB may serve to ensure that the LOB, unlike typical business transactions, is publicly available and immutable. Accordingly, greater confidence may be placed in such publicly recorded agreements than in typical lease agreements, which are maintained as private business records. Thus, the technical implementation of the LOB in a distributed ledger helps replicate the assurance of title-based real estate transactions that are maintained by government records departments. Alternatively, the transaction details may be kept private unless one or all parties to the LOB decides to publish them.

When these effects are considered in aggregate, one or more of the methodologies described herein may obviate a need for certain efforts or resources that otherwise would be involved in real estate transactions. Computing resources used by one or more machines, databases, or networks may similarly be reduced. Examples of such computing resources include processor cycles, network traffic, memory usage, data storage capacity, power consumption, and cooling capacity.

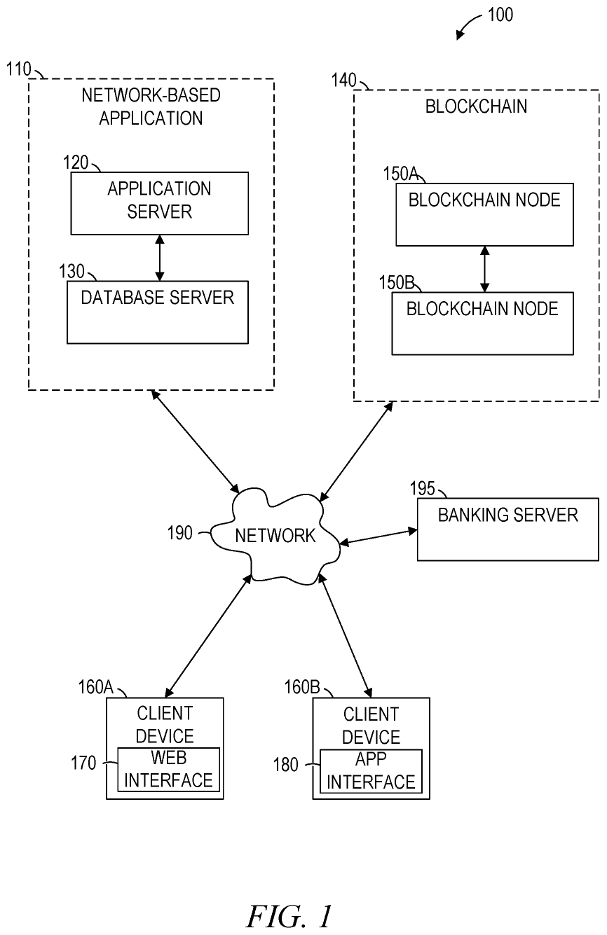

FIG. 1 is a network diagram illustrating a network environment 100 suitable for a real estate data system, according to some example embodiments. The network environment 100 includes a network-based application 110, a blockchain network 140, client devices 160A and 160B, a banking server 195, and a network 190. The network-based application 110 is provided by application server 120 in communication with a database server 130. The blockchain network 140 comprises a plurality of blockchain nodes 150A, 150B that maintain a distributed ledger. The banking server 195 provides banking services to the network-based application 110 and the client devices 160A-160B.

The application server 120 accesses application data (e.g., application data stored by the database server 130) to provide one or more applications to the client devices 160A and 160B via a web interface 170 or an application interface 180. For example, the application server 120 may provide a real estate application that receives search requests from the client devices 160, searches for responsive real estate listings, provides a user interface to select real property for a LOB, and records the LOB on a blockchain maintained by the blockchain network 140.

The nodes 150A-150B can include at least a decentralized set of computing devices and may even include personal computing devices for individuals, and so on. For example, a ledger may be stored on a large number of publicly available devices, each acting as a “node” for storing a copy of the ledger (e.g., being collaboratively maintained by anonymous peers on a network). In some examples, the ledger is only stored and maintained on a set of trusted “nodes,” such as on a private network or on the computing systems of authorized users. In some examples, a combination and/or a “mix” of both trusted nodes and public nodes may be utilized, with the same and/or different rules being applied to activities performed at each (e.g., a different validation process may be used for untrusted nodes, or untrusted nodes may be unable to perform certain activities). In some examples, there may be different levels of nodes with differing characteristics and applied logic.

The banking server 195 may provide banking services using an application programming interface (API). For example, the bank may provide a mortgage loan for real estate brokered by the network-based application 110. The application server 120 may provide a user interface to the recipient of the loan via the web interface 170 and communicate details of the loan with the banking server 195 via the API. Information regarding the mortgage loan may be stored on the distributed ledger of the blockchain network 140. After a LOB agreement is formed, lease payments from a lessee may be received by the application provider and applied to the mortgage loan by API calls from the application server 120 to the banking server 195. The distributed ledger may be updated after each successful payment.

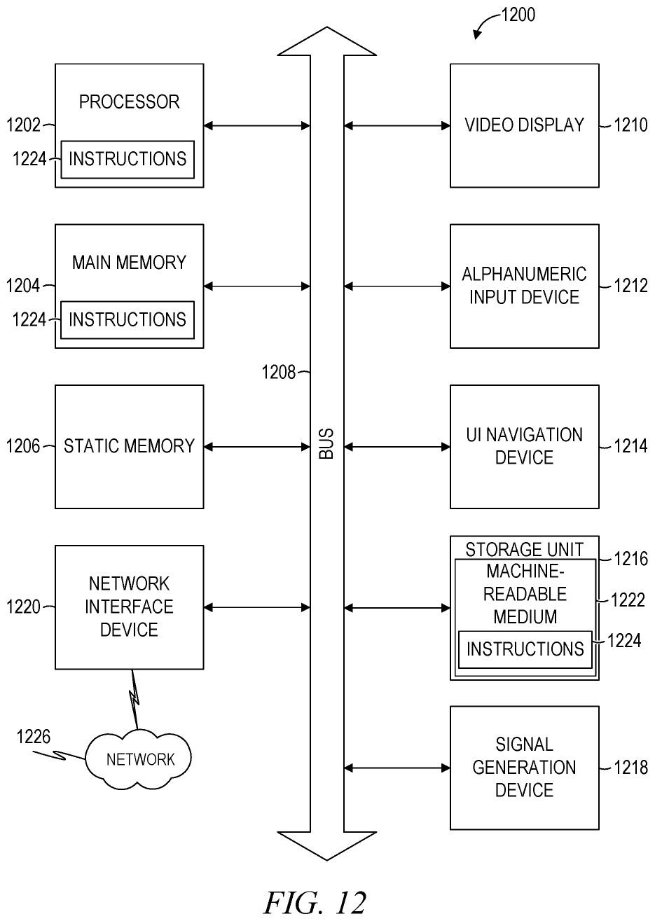

The application server 120, the database server 130, the blockchain nodes 150A and 150B, the banking server 195, and the client devices 160A and 160B may each be implemented in a computer system, in whole or in part, as described below with respect to FIG. 12. The client devices 160A and 160B may be referred to collectively as client devices 160 or generically as a client device 160. The blockchain nodes 150A and 150B may be referred to collectively as blockchain nodes 150 or generically as a blockchain node 150.

Any of the machines, databases, or devices shown in FIG. 1 may be implemented in a general-purpose computer modified (e.g., configured or programmed) by software to be a special-purpose computer to perform the functions described herein for that machine, database, or device. For example, a computer system able to implement any one or more of the methodologies described herein is discussed below with respect to FIG. 12. As used herein, a “database” is a data storage resource and may store data structured as a text file, a table, a spreadsheet, a relational database (e.g., an object-relational database), a triple store, a hierarchical data store, a document-oriented NoSQL database, a file store, or any suitable combination thereof. The database may be an in-memory database. Moreover, any two or more of the machines, databases, or devices illustrated in FIG. 1 may be combined into a single machine, database, or device, and the functions described herein for any single machine, database, or device may be subdivided among multiple machines, databases, or devices.

The application server 120, the database server 130, the blockchain nodes 150A-150B, the client devices 160A-160B, and the banking server 195 are connected by the network 190. The network 190 may be any network that enables communication between or among machines, databases, and devices. Accordingly, the network 190 may be a wired network, a wireless network (e.g., a mobile or cellular network), or any suitable combination thereof. The network 190 may include one or more portions that constitute a private network, a public network (e.g., the Internet), or any suitable combination thereof.

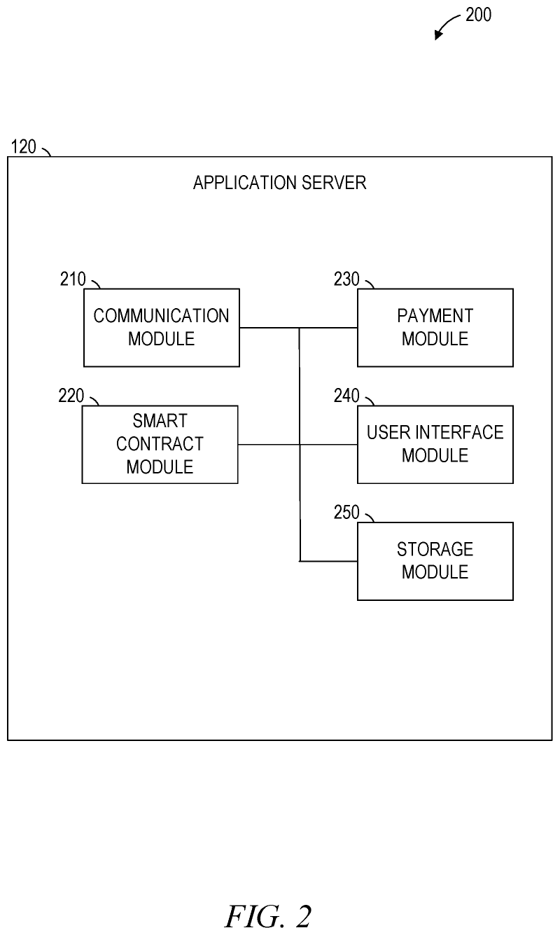

FIG. 2 is a block diagram 200 of the application server 120, according to some example embodiments, suitable for managing smart contracts for a real estate data system. The application server 120 is shown as including a communication module 210, a smart contract module 220, a payment module 230, a user interface module 240, and a storage module 250, all configured to communicate with each other (e.g., via a bus, shared memory, or a switch). Any one or more of the modules described herein may be implemented using hardware (e.g., a processor of a machine). For example, any module described herein may be implemented by a processor configured to perform the operations described herein for that module. Moreover, any two or more of these modules may be combined into a single module, and the functions described herein for a single module may be subdivided among multiple modules. Furthermore, according to various example embodiments, modules described herein as being implemented within a single machine, database, or device may be distributed across multiple machines, databases, or devices.

The communication module 210 receives data sent to the application server 120 and transmits data from the application server 120. For example, the communication module 210 may receive, from the client devices 160, search criteria for real estate listings. The user interface module 240 may access data from the storage module 250 or the database server 130 and generate a responsive user interface (e.g., hypertext markup language (HTML) describing the user interface). The communication module 210 may send data for the user interface to the client device 160 for display. The communication module 210 may also send intermediate communications between the application server 120 and the blockchain network 140. For example, entries to a distributed ledger may be created or modified by the smart contract module 220 and communicated via the communication module 210. Additionally, the communication module 210 may receive data and send instructions to the banking server 195. For example, LOB payments may be received by the payment module 230 and banking data updated via API calls to the banking server 195, sent by the communication module 210. Communications sent and received by the communication module 210 may be intermediated by the network 190.

The smart contract module 220 may create and modify smart contracts on the distributed ledger maintained by the blockchain network 140. For example, a LOB agreement may be recorded in a smart contract. The LOB agreement may include identification of the parties, identification of the real estate being leased, identification of a mortgage loan on the real estate, identification of the LOB terms such as monthly payment, effective interest rate, strike price to execute the buy option, and so on.

The storage module 250 may store data locally on the application server 120 (e.g., in a hard drive) or store data remotely. Examples of remote storage include network storage devices, the database server 130, and the distributed ledger maintained by the blockchain network 140.

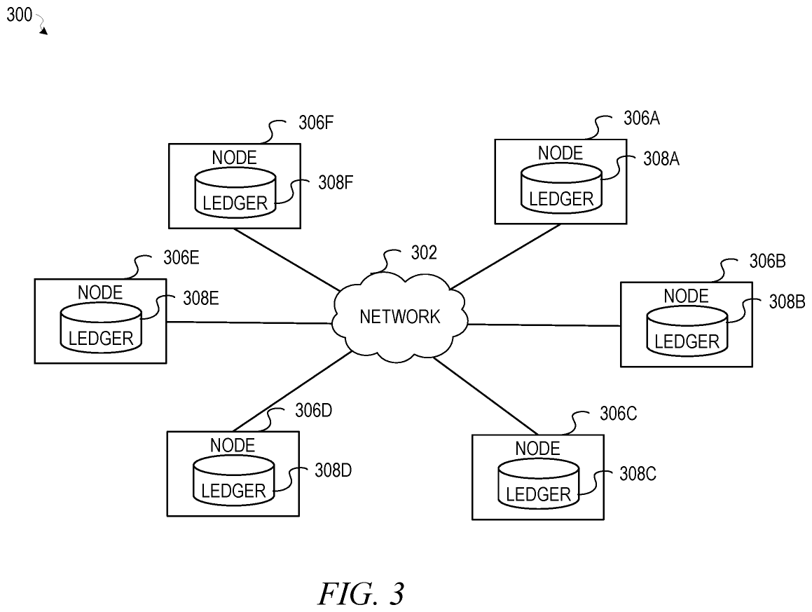

FIG. 3 is a block diagram illustrating an example of a distributed ledger system 300 that provides one or more distributed ledgers 308A-308F (generically referred to as ledger(s) 308) or blockchains across one or more nodes 306A-306F (generically referred to as node(s) 306). Non-limiting examples of a distributed ledger system 300 include, but are not limited to, Ethereum, Hyperledger Fabric, Quorum, Guardtime, KSI, and so forth. The nodes 306 can communicate via a network 302. The network 302 broadly represents one or more LANs, WANs, cellular networks (e.g., LTE, HSPA, 3G, and other cellular technologies), and/or networks using any of wired, wireless, terrestrial microwave, or satellite links, and may include the public Internet. The network 302 can be a public network or a private network. Each node 306 can be implemented using individual computing devices, distributed processing systems, servers, isolated execution environments (e.g., containers, virtual machines), shared computing resources, and so on. In some examples, the nodes 306 can be implemented on the same or as part of different isolated execution environment systems (e.g., as different containers or pods of the same or different Kubernetes cluster or Docker swarm).

In the illustrated example of FIG. 3, each node 306 is shown to include a ledger 308 (which may include more than one ledger), which can be stored across one or more data stores. In some examples, the ledger 308 of each node 306 can include one or more blockchains, etc. In some cases, the ledgers 308 of the different nodes 306 correspond to each other, include the same or matching data entries, or include the same data.

The distributed nodes 306 can store, maintain, and/or update their respective ledger 308. Each node 306 can be configured for storing a version of the distributed ledger 308 (or a portion thereof), and the distributed ledger 308 may be updated from time to time with modifications to the ledger 308 and/or ledger entries, such as insertion of a ledger entry (also referred to herein as a block) or an update of a ledger entry. The distributed ledger system 300 may be adapted such that, where issues arise with the distributed ledger 308 (e.g., hash collisions, insertions at the same time, corrupted ledgers/ledger entries), the issues are resolved based at least on issue resolution logic. For example, such logic may be distributed among each of the nodes 306 and/or their computing systems and can be used to improve or ensure consistency between copies of the ledgers 308 at the different nodes. In some examples, issues may arise that can cause a distributed ledger 308 to “fork” and/or spawn another instance, for example, where a collision cannot be automatically resolved between the nodes 306. In such cases, the resolution logic can be used to determine when to “fork” or spawn another instance, and the like.

It will be understood that each node 306 can include fewer or more components. For example, each node 306 can include processors, buffers, applications, databases, etc. In some cases, the nodes 306 can include executable instructions or code that when executed by the node 306 cause the node 306 to modify a corresponding ledger 308 or generate a transaction that is to be stored in a block of a blockchain. In some cases, the executable instructions can be chaincode and can be used to implement or execute a smart contract relative to the ledger 308.

As described herein, the nodes 306 can include at least a decentralized set of computing devices and may even include personal computing devices for individuals, and so on. For example, a ledger 308 may be stored on a large number of publicly available devices, each acting as a “node” for storing a copy of the ledger 308 (e.g., being collaboratively maintained by anonymous peers on a network). In some examples, the ledger 308 is only stored and maintained on a set of trusted “nodes,” such as on a private network or on the computing systems of authorized users. In some examples, a combination and/or a “mix” of both trusted nodes and public nodes may be utilized, with the same and/or different rules being applied to activities performed at each (e.g., a different validation process may be used for untrusted nodes, or simply untrusted nodes may be unable to perform certain activities). In some examples, there may be different levels of nodes with differing characteristics and applied logic.

The ledgers 308, ledger entries, and/or information stored on the ledger entries may be used to store information received from one or more computing devices. For example, the information may include banking information, other commercial information, smart contracts, and so forth. Further, the ledger 308 and ledger entries may utilize encryption technology to facilitate and/or validate digital signatures or the data received from the computing devices.

In some examples, the ledger 308 is publicly accessible. In some examples, the ledger 308 is only accessible to select, authorized nodes having the appropriate permissions. In some examples, portions of the ledger 308 are public and portions of the ledger 308 are private. When the ledger 308 is publicly accessible, the ledger 308 may be adapted to only store information incidental to a transaction or a document relating to a transaction, and may be adapted such that identifiable information is removed but validation information is maintained (e.g., storing a hash value computed from the underlying information). Further, the information stored on the ledger 308 may be encrypted (non-limiting example: using a public key of a key pair associated with a node 306), redacted, compressed, transformed (e.g., through a one-way transformation or a reversible transformation), and so on.

Each of the one or more nodes 306 may have, at various times, versions of the ledger 308, and the ledger 308 may be maintained through the propagation of entries and/or updates that may be copied across ledgers 308. Ledger entries may contain elements of information (e.g., header information and/or other data). There may be various rules and/or logic involved in activities relating to the ledger entries (e.g., creating, updating, validating, deleting); for example, a majority, supermajority, or unanimous consent between nodes may be enforced as a condition to an activity relating to an entry. In some examples, distributed ledgers 308 are utilized and the ledger entries are adapted to have various linkages to one another such that the integrity of the ledger entries can be reinforced and/or validated. For example, the linkages may include hashes computed based on prior entries in the ledger 308, which may be utilized to determine whether a ledger entry is a fraudulent entry by reviewing the correctness of the hash based on performing the hash on information stored on prior entries.

The ledger 308 may be maintained through, for example, a “distributed network system,” with the distributed network system providing decentralized control and storage of the ledger 308 at the one or more nodes (which may be considered “nodes” of the system). The number of “nodes” may be fixed or vary with time, and increasing or decreasing the number of “nodes” may impact the performance and/or security of the system.

The ledger 308 copies stored and maintained at each “node” provide cross-validation with one another in the event of conflicts between ledgers 308, and various cryptographic and/or hashing algorithms may be utilized during the generation, updating, deletion, linking, and so on, of ledger entries such that ledger entries have increased resiliency to unauthorized tampering or modification. For example, a blockchain ledger 308 may be distributed across nodes 306 and used to track information received from one or more computing devices. The blockchain ledger 308 may have entries linked to one another using cryptographic records, and entries in the blockchain may be ordered, time stamped, and/or associated with metadata. These and other methods can be used for protection against “double” transfers and unauthorized modification of ledger entries.

The ledger 308 may implement smart contracts. A smart contract is a program stored in the ledger that runs when predetermined conditions are met. Smart contracts have many applications. As a simple example, a smart contract may ensure that whenever tokens are paid for transference of a specific NFT, a fraction of the tokens are sent to a wallet of the creator of the NFT and the remainder of the tokens are sent to a wallet of the current owner of the NFT. As a more complex example, inter-related smart contracts allow the formation of distributed autonomous organizations (DAOs). In a DAO, modification of the DAO is permitted only according to rules that are encoded in smart contracts at the time the DAO is created. Another example use for smart contracts include multi-signature accounts that allow funds to be transferred from a wallet only when at least a predetermined number (or percentage) of users of the multi-signature account agree.

Once a smart contract is deployed to a ledger, it may be configured to listen to event updates from an “oracle,” which is a cryptographically secured data source. The smart contract executes once it receives predefined events from one or more oracles. Smart contracts may be programmed in a variety of programming languages including Solidity, WebAssembly, and Digital Asset Modeling Language.

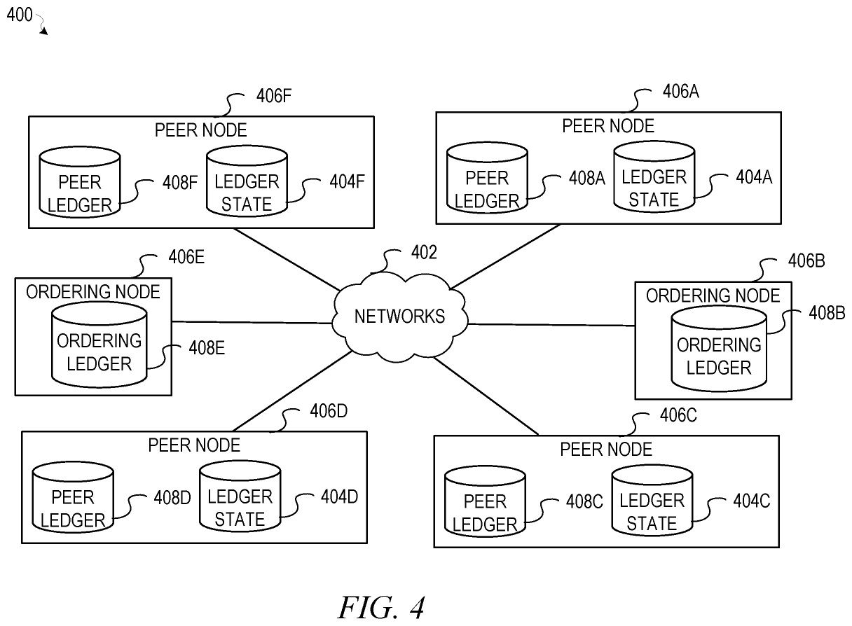

FIG. 4 is a block diagram illustrating another example of a distributed ledger system 400 that includes different types of nodes 406. Specifically, the illustrated example of FIG. 4 includes four peer nodes 406A, 406C, 406D, 406F (generically referred to as peer node(s) 406) and two ordering nodes 406B, 406E (generically referred to as ordering node(s) 406). It will be understood that fewer or more nodes can be included as desired. For example, the distributed ledger system 400 may include only one ordering node 406 or two or more ordering nodes 406. Similarly, the distributed ledger system 400 can include fewer or more peer nodes 406 as desired. The nodes 406 can communicate via a network 402. The network 402 broadly represents one or more LANs, WANs, cellular networks (e.g., LTE, HSPA, 3G, and other cellular technologies), and/or networks using any of wired, wireless, terrestrial microwave, or satellite links, and may include the public Internet. The network 402 can be a public network or a private network

As described herein, the peer nodes 406 and ordering nodes 406 can be implemented using one or more computing devices, isolated execution environments, and the like. In some examples, each peer node 406 and/or ordering node 406 can be associated with the same or different organization, entity, or user. For example, one company may be associated with or control peer nodes 406A, 406C and ordering node 406B, a second company may be associated with or control peer node 406D and ordering node 406E, and a third company may be associated with or control peer node 406F. A non-limiting example of a distributed ledger system 400 that includes peer nodes 406 and ordering nodes 406 is the Hyperledger Fabric.

For simplicity in describing FIG. 4, the peer nodes 406 and ordering nodes 406 are described with reference to a common channel that enables private communications/transactions between the illustrated nodes 406A-406F. However, it will be understood that the peer nodes 406 and ordering nodes 406 can be associated with multiple channels that each enable private communications/transactions between nodes associated with the channel and/or be associated with multiple consortiums made up of organizations that control the individual nodes 406. Further, it will be understood that each peer node 406 can include one or more peer node ledgers 408 and/or ledger states 404 and perform the functions described herein for each channel with which the peer node 406 is associated. Similarly, each ordering node 406 can include an ordering node ledger 408 and perform the functions described herein for each channel with which the ordering node 406 is associated. In some cases, each channel can include at least one ordering node 406 and multiple peer nodes 406. In certain examples, a channel is associated with multiple peer nodes 406 and only one ordering node 406. In certain cases, multiple ordering nodes 406 can be associated with the same channel.

In the illustrated example of FIG. 4, each of the peer nodes 406A, 406C, 406D, 406F includes a respective peer node ledger 408A, 408C, 408D, 408F (generically referred to as peer node ledger(s) 408) and a respective ledger state 404A, 404C, 404D, 404F (generically referred to as ledger state(s) 404), and can be used to receive proposed transactions from a client computing device (not shown), endorse transactions, communicate endorsed transactions to a client computing device or ordering node 406, validate transactions of a block, commit blocks to a respective peer node ledger 408, and/or update a respective ledger state 404.

In some examples, the peer node ledgers 408 include one or more ledgers or blockchains. Further, the peer node ledgers 408 of the different peer nodes 406 can correspond to each other, and/or include the same or matching entries, transactions, blocks, blockchains, etc. In some cases, the peer node ledger 408 can include blocks formed from validated transactions, but may exclude invalidated transactions. In certain examples, the peer node ledgers 408 can include blocks formed from validated and invalidated (or failed) transactions. In certain examples, such as examples in which an ordering node 406 maintains an ordering node ledger 408, the peer node ledgers 408 can correspond to or match the ordering node ledgers 408 of the ordering nodes 406 and/or be different. For example, in some cases, the ordering node ledgers 408 can include all endorsed transactions, regardless of whether they are validated, and the peer node ledgers 408 can include endorsed and validated transactions but not endorsed and invalidated or failed transactions. In certain examples, the peer node ledgers 408 can include one ledger or blockchain that matches the ordering node ledger 408 and another ledger that does not match the ordering node ledger 408.

In some cases, the peer node ledger 408 is generated based on blocks received from an ordering node 406. For example, the peer node 406 can review the transactions of a received block and, if a transaction is validated, can include the transaction as part of a block for the peer node ledger 408. Accordingly, in certain examples a block of a peer node 406 may have fewer transactions (or none) compared to a corresponding block received from the ordering node 406 and/or found in the ordering node ledger 408

In some examples, when a peer node ledger 408 is implemented as a blockchain, each block of the blockchain can include a header portion (including metadata) and a body portion. The header portion and/or metadata can include a block number (e.g., which block the block is in the blockchain), one or more content identifiers for the current block, a content identifier for a previous block, one or more timestamps (e.g., when block was created, added to the blockchain), a digital certificate, a public key (of a public-private key pair), a digital signature of the peer node 406 that added the block to the blockchain, and/or indicators as to whether a transaction of the block is valid/invalid, etc. In addition, in some cases, the header portion can include hashes or content identifiers for individual transactions of a block, etc., and the body portion of a block in the blockchain can include one or more transactions or transaction data associated with a transaction.

As described herein, in some cases, the transactions in a block of a peer node blockchain can include endorsed and validated transactions and/or may include validated and invalidated transactions. In certain examples, each transaction can include header information (e.g., chaincode used to generate the transaction, software version), digital signature of the client computing device that initiated the transaction, a signature or identifier of the endorsing peer nodes 406 (peer nodes 406 that signed and/or endorsed the transaction), channel information (which channel the transaction is associated with), a signature or identifier of the ordering node 406 that ordered the transaction in the block, a proposed change to the peer node ledger 408, an expected input/output of the transaction (e.g., the content of the ledger state 404 before and after the transaction is executed), etc.

The ledger state 404 can include one or more key-value pairs reflecting the value or state of the key (of the key-value pair), and can be implemented as a database in one or more data stores of a peer node 406. In some examples, the ledger state 404 reflects a current state or value of the keys based on the transactions in the corresponding peer node ledger 408 or blockchain. As a non-limiting example, if the peer node ledger 408 reflects transactions (e.g., debits and credits) associated with a particular bank account or other intangible object, the ledger state 404 can reflect the current value of money in the bank account based on all previous transactions. As another non-limiting example, the ledger state 404 can reflect a current ownership of a car or other physical object based on previous (validated) transactions associated with the car found in the peer node ledger 408. Accordingly, as a peer node 406 adds a block with one or more transactions to a peer node ledger 408 or blockchain, the peer node 406 can update the ledger state 404 for keys that were altered based on any one or any combination of the (validated) transactions of the block. Similar to the peer node ledgers 408, the ledger states 404 of the different peer nodes 406 can correspond to each other, include the same or matching key-value pairs, etc.

Although not illustrated, it will be understood that each peer node 406 can include fewer or more components. For example, as mentioned, each peer node 406 can include multiple peer node ledgers 408, as well as chaincodes, permissions, etc. This information can be stored on one or more data stores associated with the peer node 406. The permissions can indicate which channels, organizations, or other components the peer node 406 is associated with and/or what information the peer node 406 is allowed to access or edit, etc.

The chaincodes can include executable instructions that the peer node 406 is to execute and which can generate or be used to endorse or validate transactions for a block of a blockchain. For example, a chaincode can indicate that a peer node 406 is to read/write information to a ledger state 404. A client computing device (not shown) can cause the peer node 406 to execute the chaincode by providing the peer node 406 with one or more inputs. For example, if the chaincode is used to reflect the change in ownership of a car, the client computing device can identify the subject car and the identity of the parties involved in the transaction (e.g., buyer and seller). The peer node 406 can use the chaincode to verify whether the ledger state 404 includes the identified car and the parties are valid (e.g., identified owner owns the car and buyer is able to purchase the car), etc. Based on the chaincode, the relevant peer nodes 406 can endorse or validate a transaction that is to be included as part of a block in a blockchain.

In the illustrated example of FIG. 4, each of the ordering nodes 406B, 406E includes a respective ordering node ledger 408B, 408E (generically referred to as ordering node ledger(s) 408), which can be used to order endorsed transactions received from peer nodes 406, generate blocks from one or more transactions, communicate generated blocks to one or more peer nodes 406, and update a respective ordering node ledger 408. However, it will be understood that in some examples, the ordering nodes 406 do not include a ledger. In some such examples, the ordering nodes 406 may only perform the ordering and block generation functions described herein.

The ordering node ledgers 408 can include one or more ledgers or blockchains. Further, the ordering node ledgers 408 of the different ordering nodes 406 can correspond to each other, include the same or matching entries, transactions, blocks, blockchains, and the like. The ordering ledgers 408 can include blocks formed from endorsed transactions, validated transactions, invalidated transactions, not yet validated/invalidated transactions, or any suitable combination thereof. In certain examples, the ordering node ledgers 408 can correspond to or match a peer node ledger 408 of a peer node 406 and/or be different. For example, in some cases, the ordering node ledgers 408 can include all endorsed transactions, regardless of whether they are validated, and the peer node ledgers 408 can include endorsed and validated transactions but not invalidated or failed transactions. Further, in some cases, a transaction in a block of a peer node ledger 408 can include a signature of a validating peer node 406, whereas a corresponding transaction in a block of an ordering node ledger 408 may not include such a signature. In some cases, the ordering node 406 does not validate the transactions of a block before posting the block to its blockchain or ordering node ledger 408. Accordingly, the blocks of an ordering node blockchain can include transactions that later fail, are invalidated, or are determined to be invalid.

In some cases, the ordering nodes 406 can be used to order transactions received from the peer nodes 406. In certain cases, the ordering of transactions can reduce the likelihood of forks of a blockchain or the ledger state 404 being different across peer nodes 406, etc. In some examples, the ordering nodes 406 can order the nodes based on a time of receipt and/or a timestamp associated with the transaction creation. In some cases, the ordering nodes 406 can order the transactions chronologically. In addition to ordering transactions, an ordering node 406 can generate a block that is to be appended to a blockchain. In some cases, as described herein, the ordering node 406 can generate a block based on a predetermined amount of time, number of transactions, size of data, etc. Further, the order of the transactions in the generated block can correspond to the order generated by the ordering node 406. Once the block is generated, the ordering node 406 can communicate the generated block to one or more peer nodes 406 for validation and commitment to a blockchain or peer node ledger 408 and/or commit the generated block to an ordering node ledger 408.

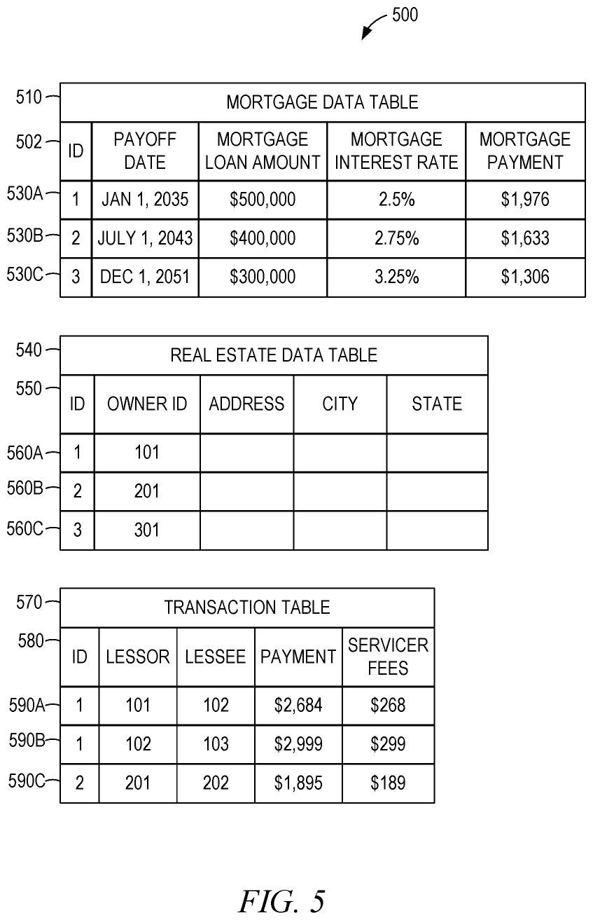

FIG. 5 is a block diagram of a database schema 500, according to some example embodiments, suitable for use in a real estate data system. The database schema 500 includes a mortgage data table 510, a real estate data table 540, and a transaction table 570. The mortgage data table 510 includes rows 530A, 530B, and 530C of a format 520. The real estate data table 540 includes rows 560A, 560B, and 560C of a format 550. The transaction table 570 includes rows 590A, 590B, and 590C of a format 580.

The format 520 of the mortgage table 510 includes a unique identifier for the property subject to a mortgage, a payoff date for the mortgage, an amount of the mortgage loan, an interest rate of the mortgage, and a monthly payment for the mortgage. Each of the rows 530A-530C stores data for a single mortgage. In various example embodiments, more or fewer fields are stored for each mortgage. For example, an origination date, an identifier of the mortgage lender, an identifier of the recipient of the mortgage loan, a current payoff amount for the mortgage, whether property taxes are included in the mortgage payment, whether mortgage insurance is included in the mortgage payment, whether homeowner's insurance is included in the mortgage payment, or any suitable combination thereof may be included in the mortgage data table 510.

The format 550 of the real estate data table 540 includes a unique identifier of a parcel of real estate, an identifier of the owner of the real estate, and an address for the real estate (e.g., street address, city, state, country, zip code, or any suitable combination thereof). The unique identifier of the real estate data table 540 may be cross-referenced with the mortgage data table 510 to determine if a particular parcel of real estate is mortgaged, who the owner of a mortgaged parcel of real estate is, or both. Each of the rows 560A-560C stores data for a single parcel of real estate. In various example embodiments, more or fewer fields are stored for each parcel of real estate. For example, the unique identifier shown in FIG. 5 may be assigned by a servicer of a LOB transaction for the real estate and an additional identifier assigned by a governmental entity (e.g., a county) may be stored in the real estate data table 540. As another example, information about one or more buildings on the real property may be stored in the real estate data table 540. For example, a square footage of a building, a number of bedrooms of the building, a number of bathrooms of the building, a year in which the building was built, zoning information about the building (e.g., single-family home, commercial, industrial, mixed-use, or any suitable combination thereof), or any suitable combination thereof may be stored in the real estate data table 540.

Each of the rows 590A-590C of the transaction table 570 includes an identifier of a parcel of real estate being transacted, an identifier of a lessor of the real estate, an identifier of a lessee of the real estate, a monthly payment for a lease between the lessor and the lessee, and a monthly servicer fee amount paid to the servicer of the transaction. Each transaction in the transaction table may be a LOB transaction. As can be seen in the rows 590A and 590B, the same parcel of real estate may be subject to multiple transactions. Lessor 101 entered into a LOB agreement with lessee 102 for a monthly payment of $2,684. Thereafter, lessee 102 became a sub-lessor of the real estate to lessee 103 for a monthly payment of $2,999. In various example embodiments, the sub-lessor may remain a party to the LOB transaction or the new LOB transaction may be directly between the owner of the real estate (e.g., lessor 101) and the new lessee (e.g., lessee 102).

In various example embodiments, more or fewer fields are stored for each transaction. For example, an origination date of the LOB, a duration of the LOB, a strike price for the LOB, an early termination fee for the LOB, terms for transferring the LOB (e.g., to identify division of further profits between the owner and the intermediating lessee), an amount of equity associated with each monthly payment, or any suitable combination thereof may be included in the transaction table 570.

By way of example, only a few rows are shown in each of the data tables of the schema 500 but data for any number of mortgages, real estate parcels, and transactions may be stored and managed by the database server 130. The schema 500 is shown as a relational database and may be so implemented. An equivalent of the schema 500 may be stored in a distributed ledger (e.g., by the blockchain network 140).

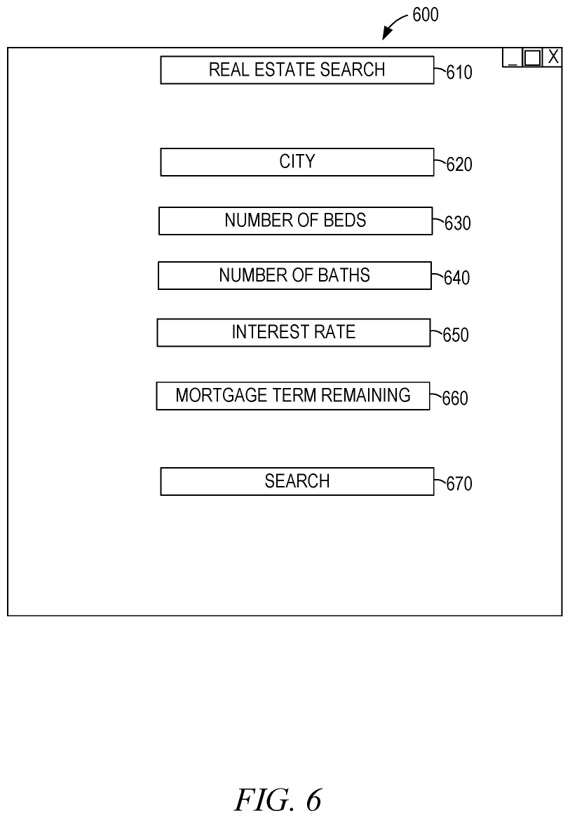

FIG. 6 is a block diagram of a user interface 600, according to some example embodiments, for searching for real estate. The user interface 600 includes a title 610, selectors 620, 630, 640, 650, and 660, and a button 670. The user interface 600 may be operable to search for real estate to buy, lease, or LOB.

The title 610 indicates that the user interface 600 is for a real estate search. The selectors 620-660 are operable to select a city, a number of beds, a number of baths, an interest rate of an existing mortgage loan, a term remaining of the existing mortgage loan, or any suitable combination thereof. The selectors 620-660 may be operable to select a specific value or a range of values. For example, the user may wish to search for houses in a specific city, an entire state, or another geographic region (e.g., within 50 miles of an identified city center). As another example, the user may wish to search for houses with exactly three bedrooms, with three or four bedrooms, or with at least three bedrooms. As still another example, the user may search for houses with existing mortgages with a specific interest rate or an interest rate equal to or below an identified threshold (e.g., 4%). As yet another example, the user may search for real estate with existing mortgages with a specific term remaining or a term equal to or above an identified threshold (e.g., five years).

In various example embodiments, more or fewer selectors may be used. For example, a selector may be added that allows the user to filter for property for which the owner is open to a LOB transaction instead of a sale transaction. A map view may be provided to allow the user to select a region graphically instead of by city name.

The button 670 is operable to submit a search query to the application server 120. The search query includes the search criteria specified using the selectors 620-660. In response to receiving the search query, the application server 120 identifies responsive real estate listings and provides them to the user (e.g., by sending a web page via the network 190 for display using the web interface 170).

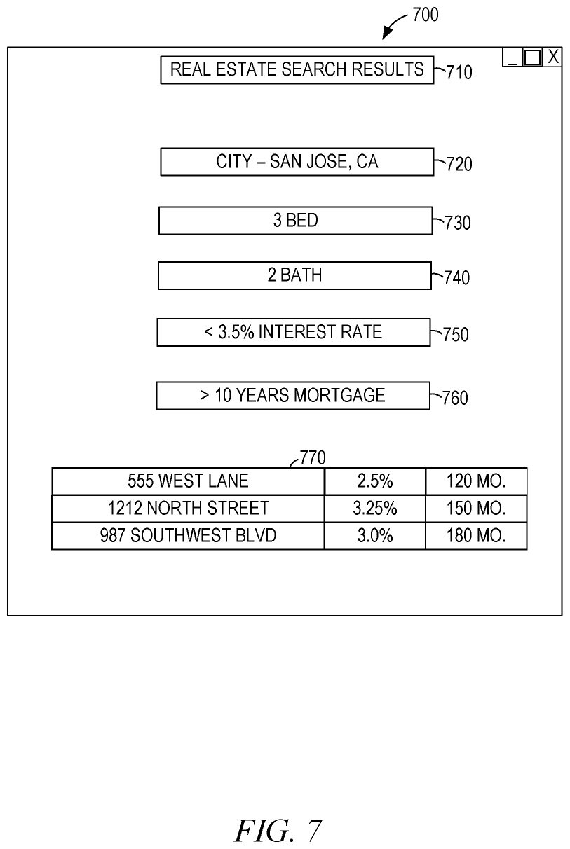

FIG. 7 is a block diagram of a user interface 700, according to some example embodiments, for displaying real estate search results. The user interface 700 includes a title 710, filters 720, 730, 740, 750, and 760, and results 770. The user interface 700 may be displayed in response to operation of the button 670 of FIG. 6.

The title 710 indicates that the user interface 700 is for results of a real estate search. The filters 720-740 indicate that the search is for real estate in San Jose, California with three bedrooms and two bathrooms. The filters 750 and 760 indicate that the search is for real estate with an existing mortgage loan at an interest rate of 3.5% or lower and with a term of at least ten years remaining.

The results 770 show multiple real estate listings that are responsive to the filters 720-760. For each listing, an address, an interest rate for an existing mortgage loan, and a term remaining on the existing mortgage loan are shown. Each of the results 770 may be operable to cause display of additional information regarding the corresponding real estate. For example, pressing or clicking on “555 West Lane” may cause display of photos of the property, a map showing the location of the property, a square footage of the property, an asking price for the property, an effective interest rate of a LOB for the property, or any suitable combination thereof.

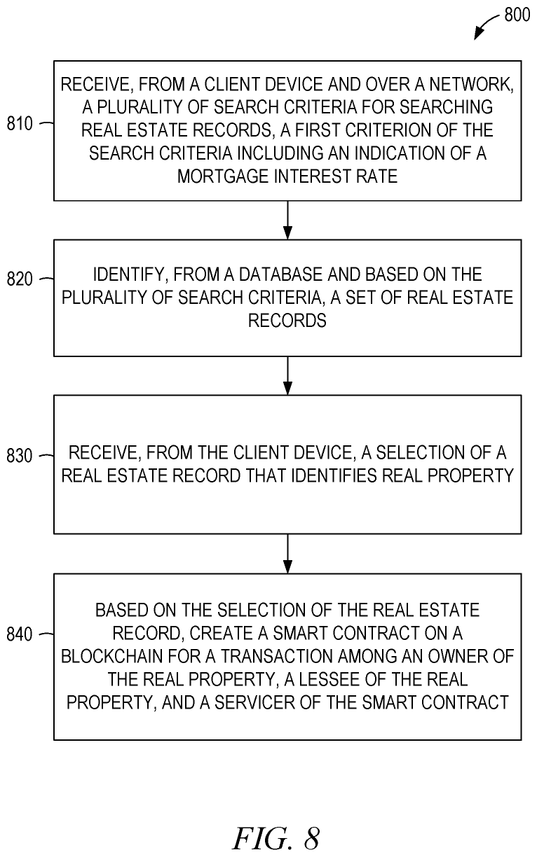

FIG. 8 is a flowchart illustrating operations of a method 800 suitable for identifying real estate and creating a smart contract for the real estate, according to some example embodiments. The method 800 includes operations 810, 820, 830, and 840. By way of example and not limitation, the method 800 may be performed by the application server 120 of FIG. 1, using the modules, databases, blockchain network, and user interfaces shown in FIGS. 2-7.

In operation 810, the user interface module 240 of the application server 120 receives, from a client device (e.g., the client device 160A) and over a network (e.g., the network 190), a plurality of search criteria for searching real estate records, a first criterion of the search criteria including an indication of a mortgage interest rate. For example, the user interface 600 of FIG. 6 may be presented on a display device of the client device 160A. The user of the client device 160A may provide values for two or more of the selectors 620-690, including a mortgage interest rate value for the selector 650. The user of the client device 160A may press the button 670, causing the client device 160A to send a request to the application server 120 via the network 190, with the request including the set values for the selectors 620-690.

The application server 120, in operation 820, identifies a set of real estate records from a database and based on the plurality of search criteria. For example, data stored in the tables of the database schema 500 of FIG. 5 may be accessed to identify responsive real estate records. For example, the real estate data table 540 includes city and state fields that may be used to filter by a city identified in the selector 620. The mortgage data table 510 includes an identifier field for cross-referencing with the real estate data table 540 and identifies a mortgage interest rate and a payoff date for a mortgage on the real estate. The payoff date may be used in conjunction with a current date to determine a term remaining on the mortgage. Information for the identified real estate may be presented on the user interface 700 of FIG. 7.

In operation 830, the application server 120 receives, from the client device, a selection of a real estate record that identifies real property. For example, the user may select one of the responsive records from the results 770 of FIG. 7. Further user interfaces may be provided to allow the user to review or modify terms and conditions of a purchase or LOB for the selected real estate.

The smart contract module 220, in operation 840, based on the selection of the real estate record, creates a smart contract on a blockchain for a transaction among an owner of the real property, a lessee of the real property, and a servicer of the smart contract. For example, a LOB may be created in which the lessee leases the real property from the owner with an option to buy and the servicer of the smart contract collects lease payments on behalf of the owner and the lender of a mortgage loan on the real property. The smart contract may be stored using the blockchain network 140 of FIG. 1. In alternative embodiments, contract data is stored in a database of the database server 130.

The smart contract for the LOB may indicate an interest rate of a mortgage on the real property to the lessor of the real estate, a market interest rate when the smart contract was created, an effective interest rate for a pseudo-mortgage to the lessee, or any suitable combination thereof. For example, real property worth $1,000,000 may have an existing loan in the amount of $600,000 at 3%. The market interest rate at the time the LOB is created may be 6%. A sales transaction with a 20% down payment would accept $200,000 from the buyer at the time of purchase, with monthly mortgage payments of approximately $4,800 for 30 years. The same loan at 4.5% would have monthly payments of approximately $4,100. Thus, a LOB transaction may be executed with an effective interest rate of 4.5% by having the lessee pay $200,000 up front and monthly payments of $4,100. The LOB would initially begin with a strike price of $800,000, which would be reduced according to the same schedule as a mortgage, dividing the monthly payments between interest and principal. No actual mortgage is created to the lessee, but the financial impact is similar to a mortgage. Accordingly, the terms of the LOB may be referred to as a pseudo-mortgage. The smart contract may include a monthly payment amount determined based on the interest rate of the mortgage and the market interest rate when the smart contract is created or an effective interest rate agreed by the parties.

A bank that issued a mortgage to the lessor of the real estate may be an additional party to the transaction. Thus, the smart contract may directly apportion monthly payments from the lessee between the bank, the lessor, and the servicer instead of having the servicer receive all funds and then disburse them appropriately.

Once the smart contract is created, the smart contract may automatically, based on detecting a monthly payment from the lessee, update a strike price of the smart contract. For example, the strike price may be reduced by the principal portion of the pseudo-mortgage reflected by the LOB. The smart contract may also indicate if the upfront payment is refundable, partially refundable, or non-refundable if the LOB agreement is terminated. The LOB agreement, as recorded in the smart contract, may include prepayment penalties, terms and restrictions of the mortgage, or both.

Creation of the smart contract by the application server 120 may be based on the location of the real property. For example, countries, states, counties, and cities may have different regulations that apply to the transfer or lease of real property. Accordingly, different terms and conditions may be present in the smart contract to comply with the applicable regulations.

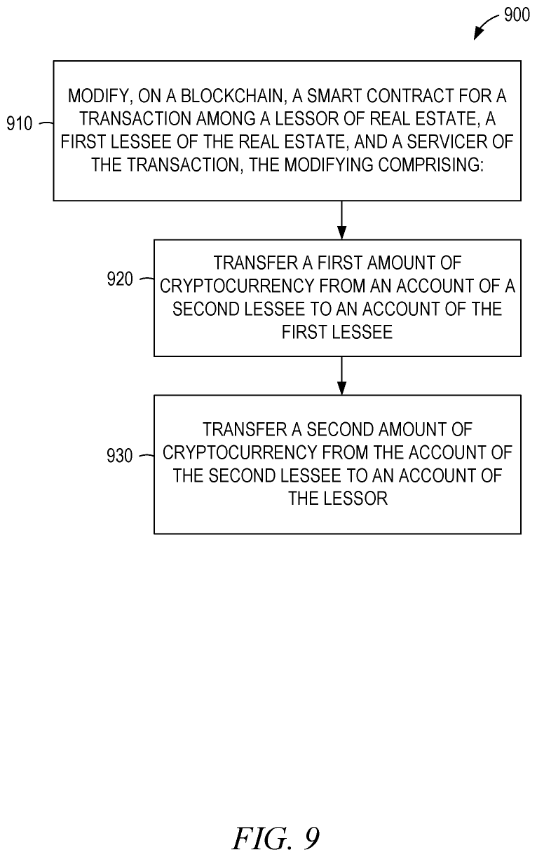

FIG. 9 is a flowchart illustrating operations of a method 900 suitable for modifying a smart contract for real estate, according to some example embodiments. The method 900 includes operations 910, 920, and 930. By way of example and not limitation, the method 900 may be performed by the application server 120 of FIG. 1, using the modules, databases, blockchain network, and user interfaces shown in FIGS. 2-7.

In operation 910, the smart contract module 220 modifies a smart contract on a block chain, the smart contract being for a transaction among a lessor of real estate, a first lessee of the real estate, and a servicer of the transaction. For example, the smart contract may have been created using the method 800. The modifying of the smart contract comprises operation 920 and 930.

The smart contract module 220, in operations 920 and 930, transfers a first amount of cryptocurrency from an account of a second lessee to an account of the first lessee and a second amount of cryptocurrency from the account of the second lessee to an account of the lessor. For example, the first lessee may be transferring a LOB to the second lessee. According to the terms of the smart contract, the first lessee may be entitled to a portion of an initial lump sum payment (similar to a down payment for a traditional mortgage) from the second lessee. The transfer of cryptocurrency may be facilitated by the blockchain network 140 according to terms of the smart contract without intervention by the servicer. Alternatively, the servicer of the LOB may intermediate the transaction, receiving funds from the second lessee and distributing them according to the terms of the contract (e.g., a portion to the first lessee, a portion to the lessor, a portion to the servicer, or any suitable combination thereof).

The first amount of cryptocurrency may be based on a market interest rate when the smart contract is modified. For example, if a mortgage on the property has a 3% interest rate, the market interest rate when the smart contract was created was 6%, and the market interest rate when the smart contract is modified is 8%, the value of the below-market mortgage rate has increased during the time that the first lessee held the LOB. Accordingly, the amount paid to the first lessee when the LOB is transferred to the second lessee may be based on the difference between the market interest rate when the smart contract was created and when the smart contract is modified.

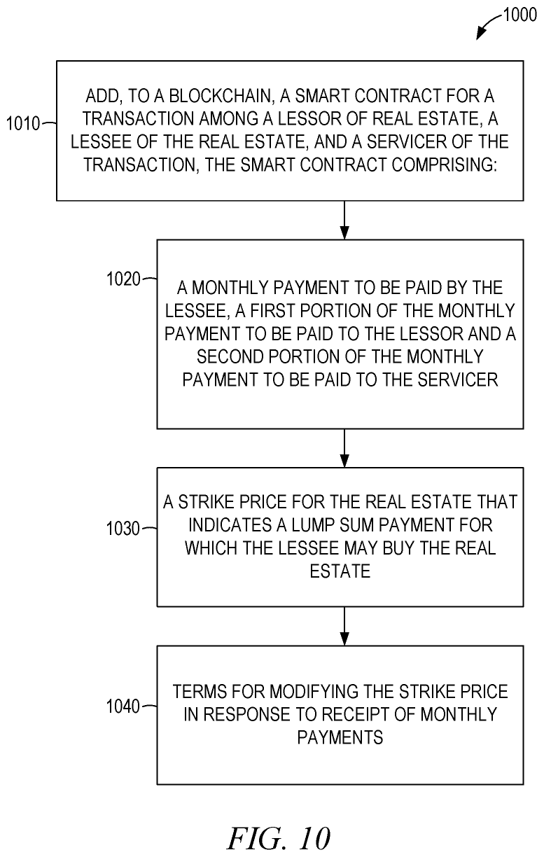

FIG. 10 is a flowchart illustrating operations of a method 1000 suitable for creating a smart contract for real estate, according to some example embodiments. The method 1000 includes operation 1010 and contract elements 1020, 1030, and 1040. By way of example and not limitation, the method 1000 may be performed by the application server 120 of FIG. 1, using the modules, databases, blockchain network, and user interfaces shown in FIGS. 2-7.

The smart contract module 220, in operation 1010, adds, to a blockchain, a smart contract for a transaction among an owner of real property, a lessee of the real property, and a servicer of the transaction. For example, a LOB may be created in which the lessee leases the real property from the owner with an option to buy and the servicer of the smart contract collects lease payments on behalf of the owner and the lender of a mortgage loan on the real property. The smart contract may be stored using the blockchain network 140 of FIG. 1. In alternative embodiments, contract data is stored in a database of the database server 130.

The smart contract comprises a monthly payment to be paid by the lessee, a first portion of the monthly payment to be paid to the lessor and a second portion of the monthly payment to be paid to the servicer (element 1020). For example, the monthly payment by the lessee may be $4,000, of which $3,600 is to be paid to the lessor and $400 is to be paid to the servicer. A bank that issued a mortgage to the lessor of the real estate may be an additional party to the transaction. Thus, the smart contract may directly apportion monthly payments from the lessee between the bank, the lessor, and the servicer instead of having the servicer receive all funds and then disburse them appropriately.

The smart contract also comprises a strike price for the real estate that indicates a lump sum payment for which the lessee may buy the real estate (element 1030). For example, a LOB for real property worth $1,000,000 may begin with a $200,000 deposit by the lessee and a strike price of $800,000 (the difference between the value of the property and the deposit).

Terms for modifying the strike price in response to receipt of monthly payments (element 1040) are also included in the smart contract. For example, the strike price may be reduced by a fixed amount with each monthly payment. As another example, the rate of reduction of the strike price may mimic the rate of principal payments on a mortgage, such that later payments reduce the strike price by a greater amount than earlier payments. The terms may be defined with reference to an interest rate, loan amount, and loan term that the LOB is in place of. For example, a 30-year mortgage at 6% interest with an $800,000 loan defines both a monthly payment and the amount of principal that is paid with each monthly payment. The LOB may simulate such a mortgage by using the same monthly payment and the same schedule for reducing the strike price. Thus, as each monthly payment is received, the strike price of the LOB is updated according to the terms of the smart contract.

The smart contract for the LOB may indicate an interest rate of a mortgage on the real property to the lessor of the real estate, a market interest rate when the smart contract was created, an effective interest rate for a pseudo-mortgage to the lessee, or any suitable combination thereof. For example, real property worth $1,000,000 may have an existing loan in the amount of $600,000 at 3%. The market interest rate at the time the LOB is created may be 6%. A sales transaction with a 20% down payment would accept $200,000 from the buyer at the time of purchase, with monthly mortgage payments of approximately $4,800 for 30 years. The same loan at 4.5% would have monthly payments of approximately $4,100. Thus, a LOB transaction may be executed with an effective interest rate of 4.5% by having the lessee pay $200,000 up front and monthly payments of $4,100. The LOB would initially begin with a strike price of $800,000, which would be reduced according to the same schedule as a mortgage, dividing the monthly payments between interest and principal. No actual mortgage is created to the lessee, but the financial impact is similar to a mortgage. Accordingly, the terms of the LOB may be referred to as a pseudo-mortgage. The smart contract may include a monthly payment amount determined based on the interest rate of the mortgage and the market interest rate when the smart contract is created or an effective interest rate agreed by the parties.

Once the smart contract is created, the smart contract may automatically, based on detecting a monthly payment from the lessee, update the strike price of the smart contract. For example, the strike price may be reduced by the principal portion of the pseudo-mortgage reflected by the LOB. The smart contract may also indicate if the upfront payment is refundable, partially refundable, or non-refundable if the LOB agreement is terminated. The LOB agreement, as recorded in the smart contract, may include prepayment penalties, terms and restrictions of the mortgage, or both.

Creation of the smart contract by the application server 120 may be based on the location of the real property. For example, countries, states, counties, and cities may have different regulations that apply to the transfer or lease of real property. Accordingly, different terms and conditions may be present in the smart contract to comply with the applicable regulations.

The terms of the smart contract may be publicly-available to anyone with access to the blockchain or kept private (e.g., by encrypting the terms). When the terms of the smart contract are kept private, one or more parties to the smart contract may have the option of publishing the terms. For example, each party may receive the decryption key for encrypted terms and, by distributing the encryption key, enable others to access them. As a result, the existence of the contract is recorded on the blockchain, but the privacy of the parties may be maintained unless and until such privacy is no longer desired.

The smart contract may be digitally signed by the servicer of the transaction. The signature may serve to authenticate the LOB.

In view of the above-described implementations of subject matter this application discloses the following list of examples, wherein one feature of an example in isolation or more than one feature of an example, taken in combination and, optionally, in combination with one or more features of one or more further examples are further examples also falling within the disclosure of this application.

Example 1 is a method comprising: adding, by one or more processors and to a blockchain, a smart contract for a transaction among a lessor of real estate, a lessee of the real estate, and a servicer of the transaction, the smart contract comprising: a monthly payment to be paid by the lessee, a first portion of the monthly payment to be paid to the lessor and a second portion of the monthly payment to be paid to the servicer; a strike price for the real estate that indicates a lump sum payment for which the lessee may buy the real estate; and terms for modifying the strike price in response to receipt of monthly payments.

In Example 2, the subject matter of Example 1 includes signing, by the servicer of the transaction, the smart contract.

In Example 3, the subject matter of Examples 1-2, wherein the monthly payment is based on a current price of the real estate, an interest rate of a mortgage on the real estate, and a current mortgage interest rate when the smart contract is created.

In Example 4, the subject matter of Examples 1-3 includes receiving, from a client device and over a network, a plurality of search criteria for searching real estate records, a first criterion of the plurality of search criteria including an indication of a mortgage interest rate; identifying, from a database and based on the plurality of search criteria, a set of real estate records; and receiving, from the client device, a selection of a real estate record that identifies the real estate; wherein the adding of the smart contract to the blockchain is based on the selection of the real estate record.

In Example 5, the subject matter of Examples 1-4, wherein the smart contract for the transaction indicates: an interest rate of a mortgage to the lessor of the real estate; and a market interest rate when the smart contract was created.

In Example 6, the subject matter of Examples 1-5, wherein a bank that issued a mortgage to the lessor of the real estate is an additional party to the transaction.

In Example 7, the subject matter of Examples 1-6 includes automatically, by the smart contract, based on detecting a payment from the lessee, updating the strike price of the smart contract according to the terms.

In Example 8, the subject matter of Examples 1-7 includes modifying the smart contract, the modifying comprising: replacing the lessee of the real estate with a second lessee; transferring a first amount of cryptocurrency from an account of the second lessee to an account of the lessee; and transferring a second amount of cryptocurrency from the account of the second lessee to an account of the lessor.

In Example 9, the subject matter of Example 8, wherein the first amount of the cryptocurrency is based on a market interest rate when the smart contract is modified.

Example 10 is a system comprising: a memory that stores instructions; and one or more processors configured by the instructions to perform operations comprising: adding, to a blockchain, a smart contract for a transaction among a lessor of real estate, a lessee of the real estate, and a servicer of the transaction, the smart contract comprising: a monthly payment to be paid by the lessee, a first portion of the monthly payment to be paid to the lessor and a second portion of the monthly payment to be paid to the servicer; a strike price for the real estate that indicates a lump sum payment for which the lessee may buy the real estate; and terms for modifying the strike price in response to receipt of monthly payments.

In Example 11, the subject matter of Example 10, wherein the operations further comprise: signing, by the servicer of the transaction, the smart contract.

In Example 12, the subject matter of Examples 10-11, wherein the monthly payment is based on a current price of the real estate, an interest rate of a mortgage on the real estate, and a current mortgage interest rate when the smart contract is created.

In Example 13, the subject matter of Examples 10-12, wherein the operations further comprise: receiving, from a client device and over a network, a plurality of search criteria for searching real estate records, a first criterion of the plurality of search criteria including an indication of a mortgage interest rate; identifying, from a database and based on the plurality of search criteria, a set of real estate records; and receiving, from the client device, a selection of a real estate record that identifies the real estate; wherein the adding of the smart contract to the blockchain is based on the selection of the real estate record.

In Example 14, the subject matter of Examples 10-13, wherein the smart contract for the transaction indicates: an interest rate of a mortgage to the lessor of the real estate; and a market interest rate when the smart contract was created.

In Example 15, the subject matter of Examples 10-14, wherein a bank that issued a mortgage to the lessor of the real estate is an additional party to the transaction.

In Example 16, the subject matter of Examples 10-15, wherein the operations further comprise: automatically, by the smart contract, based on detecting a payment from the lessee, updating the strike price of the smart contract according to the terms.

In Example 17, the subject matter of Examples 10-16, wherein the operations further comprise: modifying the smart contract, the modifying comprising: replacing the lessee of the real estate with a second lessee; transferring a first amount of cryptocurrency from an account of the second lessee to an account of the lessee; and transferring a second amount of cryptocurrency from the account of the second lessee to an account of the lessor.

Example 18 is a non-transitory computer-readable medium that stores instructions that, when executed by one or more processors, cause the one or more processors to perform operations comprising: adding, to a blockchain, a smart contract for a transaction among a lessor of real estate, a lessee of the real estate, and a servicer of the transaction, the smart contract comprising: a monthly payment to be paid by the lessee, a first portion of the monthly payment to be paid to the lessor and a second portion of the monthly payment to be paid to the servicer; a strike price for the real estate that indicates a lump sum payment for which the lessee may buy the real estate; and terms for modifying the strike price in response to receipt of monthly payments.

In Example 19, the subject matter of Example 18, wherein the operations further comprise: signing, by the servicer of the transaction, the smart contract.

In Example 20, the subject matter of Examples 18-19, wherein the monthly payment is based on a current price of the real estate, an interest rate of a mortgage on the real estate, and a current mortgage interest rate when the smart contract is created.

Example 21 is at least one machine-readable medium including instructions that, when executed by processing circuitry, cause the processing circuitry to perform operations to implement of any of Examples 1-20.

Example 22 is an apparatus comprising means to implement any of Examples 1-20.

Example 23 is a system to implement any of Examples 1-20.

Example 24 is a method to implement any of Examples 1-20.

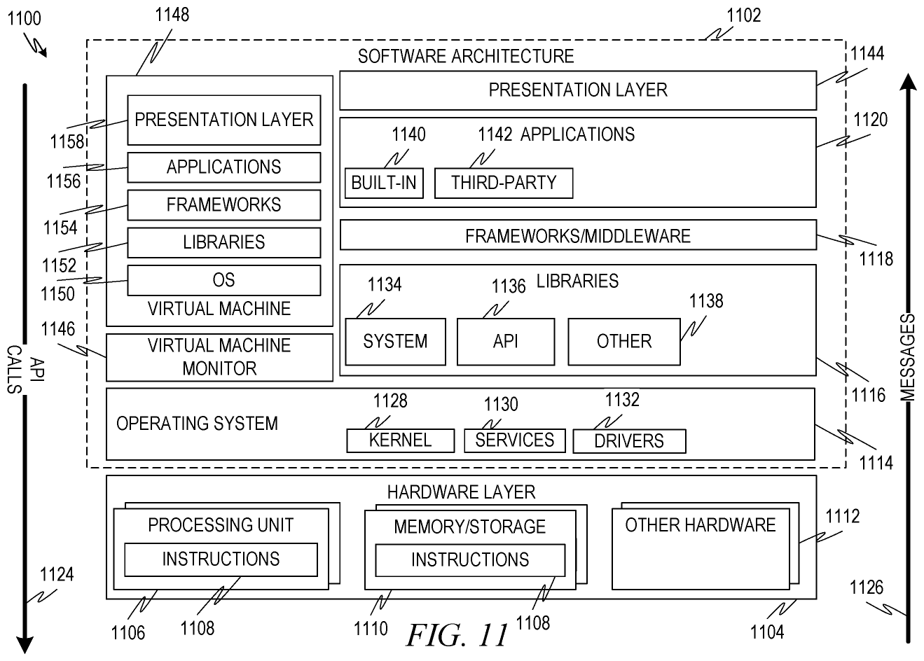

FIG. 11 is a block diagram 1100 showing one example of a software architecture 1102 for a computing device. The architecture 1102 may be used in conjunction with various hardware architectures, for example, as described herein. FIG. 11 is merely a non-limiting example of a software architecture and many other architectures may be implemented to facilitate the functionality described herein. A representative hardware layer 1104 is illustrated and can represent, for example, any of the above referenced computing devices. In some examples, the hardware layer 1104 may be implemented according to the architecture of the computer system of FIG. 11.

The representative hardware layer 1104 comprises one or more processing units 1106 having associated executable instructions 1108. Executable instructions 1108 represent the executable instructions of the software architecture 1102, including implementation of the methods, modules, subsystems, and components, and so forth described herein and may also include memory and/or storage modules 1110, which also have executable instructions 1108. Hardware layer 1104 may also comprise other hardware as indicated by other hardware 1112 which represents any other hardware of the hardware layer 1104, such as the other hardware illustrated as part of the software architecture 1102.

In the example architecture of FIG. 11, the software architecture 1102 may be conceptualized as a stack of layers where each layer provides particular functionality. For example, the software architecture 1102 may include layers such as an operating system 1114, libraries 1116, frameworks/middleware layer 1118, applications 1120, and presentation layer 1144. Operationally, the applications 1120 and/or other components within the layers may invoke API calls 1124 through the software stack and access a response, returned values, and so forth illustrated as messages 1126 in response to the API calls 1124. The layers illustrated are representative in nature and not all software architectures have all layers. For example, some mobile or special purpose operating systems may not provide a frameworks/middleware layer 1118, while others may provide such a layer. Other software architectures may include additional or different layers.

The operating system 1114 may manage hardware resources and provide common services. The operating system 1114 may include, for example, a kernel 1128, services 1130, and drivers 1132. The kernel 1128 may act as an abstraction layer between the hardware and the other software layers. For example, the kernel 1128 may be responsible for memory management, processor management (e.g., scheduling), component management, networking, security settings, and so on. The services 1130 may provide other common services for the other software layers. In some examples, the services 1130 include an interrupt service. The interrupt service may detect the receipt of an interrupt and, in response, cause the architecture 1102 to pause its current processing and execute an interrupt service routine (ISR) when an interrupt is accessed.

The drivers 1132 may be responsible for controlling or interfacing with the underlying hardware. For instance, the drivers 1132 may include display drivers, camera drivers, Bluetooth® drivers, flash memory drivers, serial communication drivers (e.g., Universal Serial Bus (USB) drivers), Wi-Fi® drivers, near-field communication (NFC) drivers, audio drivers, power management drivers, and so forth depending on the hardware configuration.

The libraries 1116 may provide a common infrastructure that may be utilized by the applications 1120 and/or other components and/or layers. The libraries 1116 typically provide functionality that allows other software modules to perform tasks in an easier fashion than to interface directly with the underlying operating system 1114 functionality (e.g., kernel 1128, services 1130 and/or drivers 1132). The libraries 1116 may include system libraries 1134 (e.g., C standard library) that may provide functions such as memory allocation functions, string manipulation functions, mathematic functions, and the like. In addition, the libraries 1116 may include API libraries 1136 such as media libraries (e.g., libraries to support presentation and manipulation of various media format such as MPEG4, H.264, MP3, AAC, AMR, JPG, PNG), graphics libraries (e.g., an OpenGL framework that may be used to render two-dimensional and three-dimensional in a graphic content on a display), database libraries (e.g., SQLite that may provide various relational database functions), web libraries (e.g., WebKit that may provide web browsing functionality), and the like. The libraries 1116 may also include a wide variety of other libraries 1138 to provide many other APIs to the applications 1120 and other software components/modules.

The frameworks/middleware layer 1118 may provide a higher-level common infrastructure that may be utilized by the applications 1120 and/or other software components/modules. For example, the frameworks/middleware layer 1118 may provide various graphic user interface (GUI) functions, high-level resource management, high-level location services, and so forth. The frameworks/middleware layer 1118 may provide a broad spectrum of other APIs that may be utilized by the applications 1120 and/or other software components/modules, some of which may be specific to a particular operating system or platform.

The applications 1120 include built-in applications 1140 and/or third-party applications 1142. Examples of representative built-in applications 1140 may include, but are not limited to, a contacts application, a browser application, a book reader application, a location application, a media application, a messaging application, and/or a game application. Third-party applications 1142 may include any of the built-in applications as well as a broad assortment of other applications. In a specific example, the third-party application 1142 (e.g., an application developed using the Android™ or iOS™ software development kit (SDK) by an entity other than the vendor of the particular platform) may be mobile software running on a mobile operating system such as iOS™, Android™, Windows® Phone, or other mobile computing device operating systems. In this example, the third-party application 1142 may invoke the API calls 1124 provided by the mobile operating system such as operating system 1114 to facilitate functionality described herein.

The applications 1120 may utilize built in operating system functions (e.g., kernel 1128, services 1130 and/or drivers 1132), libraries (e.g., system libraries 1134, API libraries 1136, and other libraries 1138), and frameworks/middleware layer 1118 to create user interfaces to interact with users of the system. Alternatively, or additionally, in some systems, interactions with a user may occur through a presentation layer, such as presentation layer 1144. In these systems, the application/module “logic” can be separated from the aspects of the application/module that interact with a user.

Some software architectures utilize virtual machines. In the example of FIG. 11, this is illustrated by virtual machine 1148. A virtual machine creates a software environment where applications/modules can execute as if they were executing on a hardware computing device. A virtual machine is hosted by a host operating system (operating system 1114) and typically, although not always, has a virtual machine monitor 1146, which manages the operation of the virtual machine as well as the interface with the host operating system (i.e., operating system 1114). A software architecture executes within the virtual machine 1148 such as an operating system 1150, libraries 1152, frameworks/middleware 1154, applications 1156 and/or presentation layer 1158. These layers of software architecture executing within the virtual machine 1148 can be the same as corresponding layers previously described or may be different.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. In example embodiments, one or more computer systems (e.g., a standalone, client, or server computer system) or one or more hardware processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or another programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired), or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses that connect the hardware-implemented modules). In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment, or a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., APIs).

### Electronic Apparatus and System

Example embodiments may be implemented in digital electronic circuitry, or in computer hardware, firmware, or software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a standalone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., an FPGA or an ASIC.

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or in a combination of permanently and temporarily configured hardware may be a design choice. Below are set out hardware (e.g., machine) and software architectures that may be deployed, in various example embodiments.

### Example Machine Architecture and Machine-Readable Medium

FIG. 12 is a block diagram of a machine in the example form of a computer system 1200 within which instructions 1224 may be executed for causing the machine to perform any one or more of the methodologies discussed herein. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a personal digital assistant (PDA), a cellular telephone, a web appliance, a network router, switch, or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1200 includes a processor 1202 (e.g., a central processing unit (CPU), a graphics processing unit (GPU), or both), a main memory 1204, and a static memory 1206, which communicate with each other via a bus 1208. The computer system 1200 may further include a video display unit 1210 (e.g., a liquid crystal display (LCD) or a cathode ray tube (CRT)). The computer system 1200 also includes an alphanumeric input device 1212 (e.g., a keyboard or a touch-sensitive display screen), a user interface (UI) navigation (or cursor control) device 1214 (e.g., a mouse), a storage unit 1216, a signal generation device 1218 (e.g., a speaker), and a network interface device 1220.

### Machine-Readable Medium

The storage unit 1216 includes a machine-readable medium 1222 on which is stored one or more sets of data structures and instructions 1224 (e.g., software) embodying or utilized by any one or more of the methodologies or functions described herein. The instructions 1224 may also reside, completely or at least partially, within the main memory 1204 and/or within the processor 1202 during execution thereof by the computer system 1200, with the main memory 1204 and the processor 1202 also constituting machine-readable media 1222.

While the machine-readable medium 1222 is shown in an example embodiment to be a single medium, the term “machine-readable medium” may include a single medium or multiple media (e.g., a centralized or distributed database, and/or associated caches and servers) that store the one or more instructions 1224 or data structures. The term “machine-readable medium” shall also be taken to include any tangible medium that is capable of storing, encoding, or carrying instructions 1224 for execution by the machine and that cause the machine to perform any one or more of the methodologies of the present disclosure, or that is capable of storing, encoding, or carrying data structures utilized by or associated with such instructions 1224. The term “machine-readable medium” shall accordingly be taken to include, but not be limited to, solid-state memories, and optical and magnetic media. Specific examples of machine-readable media 1222 include non-volatile memory, including by way of example semiconductor memory devices, e.g., erasable programmable read-only memory (EPROM), electrically erasable programmable read-only memory (EEPROM), and flash memory devices; magnetic disks such as internal hard disks and removable disks; magneto-optical disks; and compact disc read-only memory (CD-ROM) and digital versatile disc read-only memory (DVD-ROM) disks. A machine-readable medium is not a transmission medium.

### Transmission Medium

The instructions 1224 may further be transmitted or received over a communications network 1226 using a transmission medium. The instructions 1224 may be transmitted using the network interface device 1220 and any one of a number of well-known transfer protocols (e.g., hypertext transport protocol (HTTP)). Examples of communication networks include a local area network (LAN), a wide area network (WAN), the Internet, mobile telephone networks, plain old telephone (POTS) networks, and wireless data networks (e.g., WiFi and WiMax networks). The term “transmission medium” shall be taken to include any intangible medium that is capable of storing, encoding, or carrying instructions 1224 for execution by the machine, and includes digital or analog communications signals or other intangible media to facilitate communication of such software.

Although specific example embodiments are described herein, it will be evident that various modifications and changes may be made to these embodiments without departing from the broader spirit and scope of the disclosure. Accordingly, the specification and drawings are to be regarded in an illustrative rather than a restrictive sense. The accompanying drawings that form a part hereof show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” and “an” are herein used, as is common in patent documents, to include one or more than one instance. Finally, as used herein, the conjunction “or” refers to a non-exclusive “or,” unless specifically stated otherwise.

What is claimed is:

1. A method comprising:
adding, by one or more processors and to a blockchain, a smart contract for a transaction among a lessor of real estate, a lessee of the real estate, and a servicer of the transaction, the smart contract comprising:
a monthly payment to be paid by the lessee, a first portion of the monthly payment to be paid to the lessor and a second portion of the monthly payment to be paid to the servicer;
a strike price for the real estate that indicates a lump sum payment for which the lessee may buy the real estate; and
terms for modifying the strike price in response to receipt of monthly payments.

2. The method of claim 1, further comprising:
signing, by the servicer of the transaction, the smart contract.

3. The method of claim 1, wherein the monthly payment is based on a current price of the real estate, an interest rate of a mortgage on the real estate, and a current mortgage interest rate when the smart contract is created.

4. The method of claim 1, further comprising:
receiving, from a client device and over a network, a plurality of search criteria for searching real estate records, a first criterion of the plurality of search criteria including an indication of a mortgage interest rate;
identifying, from a database and based on the plurality of search criteria, a set of real estate records; and
receiving, from the client device, a selection of a real estate record that identifies the real estate; wherein
the adding of the smart contract to the blockchain is based on the selection of the real estate record.

5. The method of claim 1, wherein the smart contract for the transaction indicates:
an interest rate of a mortgage to the lessor of the real estate; and
a market interest rate when the smart contract was created.

6. The method of claim 1, wherein a bank that issued a mortgage to the lessor of the real estate is an additional party to the transaction.

7. The method of claim 1, further comprising:
automatically, by the smart contract, based on detecting a payment from the lessee, updating the strike price of the smart contract according to the terms.

8. The method of claim 1, further comprising:
modifying the smart contract, the modifying comprising:
replacing the lessee of the real estate with a second lessee;
transferring a first amount of cryptocurrency from an account of the second lessee to an account of the lessee; and
transferring a second amount of cryptocurrency from the account of the second lessee to an account of the lessor.

9. The method of claim 8, wherein the first amount of the cryptocurrency is based on a market interest rate when the smart contract is modified.

10. A system comprising:
a memory that stores instructions; and
one or more processors configured by the instructions to perform operations comprising:
adding, to a blockchain, a smart contract for a transaction among a lessor of real estate, a lessee of the real estate, and a servicer of the transaction, the smart contract comprising:
a monthly payment to be paid by the lessee, a first portion of the monthly payment to be paid to the lessor and a second portion of the monthly payment to be paid to the servicer;
a strike price for the real estate that indicates a lump sum payment for which the lessee may buy the real estate; and
terms for modifying the strike price in response to receipt of monthly payments.

11. The system of claim 10, wherein the operations further comprise:
signing, by the servicer of the transaction, the smart contract.

12. The system of claim 10, wherein the monthly payment is based on a current price of the real estate, an interest rate of a mortgage on the real estate, and a current mortgage interest rate when the smart contract is created.

13. The system of claim 10, wherein the operations further comprise:
receiving, from a client device and over a network, a plurality of search criteria for searching real estate records, a first criterion of the plurality of search criteria including an indication of a mortgage interest rate;
identifying, from a database and based on the plurality of search criteria, a set of real estate records; and
receiving, from the client device, a selection of a real estate record that identifies the real estate; wherein
the adding of the smart contract to the blockchain is based on the selection of the real estate record.

14. The system of claim 10, wherein the smart contract for the transaction indicates:
an interest rate of a mortgage to the lessor of the real estate; and
a market interest rate when the smart contract was created.

15. The system of claim 10, wherein a bank that issued a mortgage to the lessor of the real estate is an additional party to the transaction.

16. The system of claim 10, wherein the operations further comprise:
automatically, by the smart contract, based on detecting a payment from the lessee, updating the strike price of the smart contract according to the terms.

17. The system of claim 10, wherein the operations further comprise:
modifying the smart contract, the modifying comprising:
replacing the lessee of the real estate with a second lessee;
transferring a first amount of cryptocurrency from an account of the second lessee to an account of the lessee; and
transferring a second amount of cryptocurrency from the account of the second lessee to an account of the lessor.

18. A non-transitory computer-readable medium that stores instructions that, when executed by one or more processors, cause the one or more processors to perform operations comprising:
adding, to a blockchain, a smart contract for a transaction among a lessor of real estate, a lessee of the real estate, and a servicer of the transaction, the smart contract comprising:
a monthly payment to be paid by the lessee, a first portion of the monthly payment to be paid to the lessor and a second portion of the monthly payment to be paid to the servicer;
a strike price for the real estate that indicates a lump sum payment for which the lessee may buy the real estate; and
terms for modifying the strike price in response to receipt of monthly payments.

19. The non-transitory computer-readable medium of claim 18, wherein the operations further comprise:
signing, by the servicer of the transaction, the smart contract.

20. The non-transitory computer-readable medium of claim 18, wherein the monthly payment is based on a current price of the real estate, an interest rate of a mortgage on the real estate, and a current mortgage interest rate when the smart contract is created.
